(19) United States
(12) Patent Application Publication
(10) Pub. No.: US 2025/0333304 A1
(43) Pub. Date: Oct. 30, 2025

(54) METHOD FOR PRODUCING HIGH-PURITY HYDROCHLORIC ACID

(71) Applicant: TOKUYAMA CORPORATION, Yamaguchi (JP)

(72) Inventors: Naoto MOCHIZUKI, Yamaguchi (JP); Ryuma TANAKA, Yamaguchi (JP); Akihiro SAITO, Yamaguchi (JP)

(73) Assignee: TOKUYAMA CORPORATION, Yamaguchi (JP)

(21) Appl. No.: 18/873,058

(22) PCT Filed: May 18, 2023
(86) PCT No.: PCT/JP2023/018564

§ 371 Date: Dec. 9, 2024

(30) Foreign Application Priority Data
Jun. 10, 2022 (JP) 2022-094077

(51) Int. Cl. C01B 7/07

(52) U.S. Cl. CPC C01B 7/0706; C01B 2210/0042; C01P 2006/80

(57) ABSTRACT

The present invention provides a method including bringing hydrogen chloride gas into gas-liquid contact with crude hydrochloric acid that has a hydrogen chloride concentration of less than the saturation value and that contains low-boiling-point impurities, suitably at least one selected from hydrogen, nitrogen, oxygen, methane, ethylene, and acetylene, wherein the gas-liquid contact of the hydrogen chloride gas is further continued after the hydrogen chloride concentration reaches the saturation value until an excess amount of 0.1% or more of the mass of the saturated hydrochloric acid has been subjected to the contact treatment.

### TECHNICAL FIELD

The present invention relates to a method for producing high-purity hydrochloric acid, specifically, a method for producing high-purity hydrochloric acid with reduced contents of low-boiling-point impurities.

### BACKGROUND ART

Hydrochloric acid is a basic industrial raw material with a wide range of applications, and particularly in recent years, it has been usefully used in the semiconductor manufacturing process for substrate etching and cleaning applications. Also, hydrogen chloride gas obtained by vaporizing this is similarly useful as etching gas and cleaning gas in the semiconductor manufacturing process. As the integration of integrated circuits increases, inclusion of impurities causes defects and deterioration of electrical characteristics, and therefore, such hydrochloric acid for semiconductor manufacturing is required to have their content as low as possible.

High-purity hydrochloric acid is produced mostly by using synthetic hydrogen chloride gas, which is synthesized directly by the reaction of chlorine and hydrogen, or byproduct hydrogen chloride gas produced in the production process of chlorinated hydrocarbons such as vinyl chloride, as a raw material, allowing it to be absorbed by water, and then subjecting it to a purification treatment. As the purification treatment at that time, a general method is to subject the crude hydrochloric acid obtained by allowing the raw material hydrogen chloride gas to be absorbed by water, to distillation or dissipation (Non Patent Literature 1). However, while this method can efficiently remove high-boiling-point components such as metallic impurities, the crude hydrochloric acid also contains significant amounts of low-boiling-point impurities such as hydrogen, methane, ethylene, and acetylene due to the production method for hydrogen chloride gas, in addition to the metallic impurities described above, posing a problem that the low-boiling-point impurities are concentrated instead.

For this reason, it is required to also perform a removal treatment of low-boiling-point impurities, and as a countermeasure, for example, an aeration treatment by passing inert gas through the crude hydrochloric acid is performed (for example, Patent Literature 1). In this aeration treatment, air, nitrogen, oxygen, carbon dioxide, argon, and other gases are shown to be used as the inert gas (Patent Literature 1, p. 2, lower left column, lines 2 to 8).

### CITATION LIST

### Patent Literature

Patent Literature 1: Japanese Patent Laid-Open Publication No. 48-66095
Patent Literature 2: Japanese Patent Laid-Open Publication No. 2016-150869
Patent Literature 3: National Publication of International Patent Application No. 2013-545704

### Non Patent Literature

Non Patent Literature 1: Suzuki, “Production and Handling of Hydrogen Chloride”, High Pressure Gas, Vol. 2, No. 4, pp. 223-231 (1965)

### SUMMARY OF INVENTION

### Technical Problem

The above method of subjecting the crude hydrochloric acid to an aeration treatment with inert gas can release and remove low-boiling-point impurities such as hydrogen, methane, ethylene, and acetylene to considerably low contents, which is meaningful. However, the removal efficiency is still not satisfactory, and further improvement is still desired.

Moreover, the gases listed above as the inert gas are certainly components that have low activity with hydrochloric acid, but they themselves are still foreign components to hydrogen chloride. When hydrochloric acid is subjected to an aeration treatment, many of the low-boiling-point impurities described above are released and removed, while certain amounts of such inert gases are inevitably newly dissolved in the hydrochloric acid.

In recent years, semiconductor integrated circuits have become increasingly miniaturized and highly integrated, and in response to this, there is a demand for even higher purity in chemical agents for semiconductor manufacturing used in their production. Under this background, it is never desirable for high-purity hydrochloric acid to contain significant amounts of gas components, even those listed as the inert gas, as long as they are foreign components to the target substance. That is, in its production, gases that fall under the category of inert gas, such as nitrogen and oxygen, are also treated as impurities that should be removed as they may be inhibiting factors for high purity (for example, Patent Literature 2 and

Table 1, and Patent Literature 3 and Table 1 and Table 2). However, it is by no means easy to completely remove the inert gas components dissolved in the aeration treatment of the crude hydrochloric acid, even if other purification means such as distillation are later performed.

From the above, it has been a big problem to develop a method for producing high-purity hydrochloric acid that can highly remove low-boiling-point impurities, and in particular, can also keep the contents of gas components that fall under the category of inert gas, such as nitrogen and oxygen, low.

### Solution to Problem

In view of the above problem, the present inventors have continued diligent investigations. As a result, they have found that the above problem can be solved by bringing a specific amount of hydrogen chloride gas into gas-liquid contact with crude hydrochloric acid that has a hydrogen chloride concentration of less than the saturation value. The present invention has been thus completed.

That is, the present invention provides a method for producing high-purity hydrochloric acid comprising bringing hydrogen chloride gas into gas-liquid contact with crude hydrochloric acid that has a hydrogen chloride concentration of less than the saturation value and that contains low-boiling-point impurities, wherein the gas-liquid contact of the hydrogen chloride gas is further continued after the hydrogen chloride concentration reaches the saturation value until an excess amount of 0.1% or more of the mass of the saturated hydrochloric acid has been subjected to the contact treatment.

### Advantageous Effects of Invention

According to the method of the present invention, low-boiling-point impurities can be highly removed from crude hydrochloric acid, and furthermore, the contents of foreign gas components that fall under the category of inert gas, such as nitrogen and oxygen, can also be kept low, enabling efficient production of high-purity hydrochloric acid.

### BRIEF DESCRIPTION OF DRAWING

FIG. 1 is a flow diagram showing a representative aspect of the method for producing high-purity hydrochloric acid of the present invention.

FIG. 2 is a flow diagram showing a method for producing high-purity hydrogen chloride gas, incorporating the method for producing high-purity hydrochloric acid shown in FIG. 1.

### DESCRIPTION OF EMBODIMENTS

Hereinafter, embodiments of the present invention will be described in detail below. However, the present invention is not limited to these embodiments.

Crude hydrochloric acid subjected to the method of the present invention is hydrochloric acid that contains low-boiling-point impurities and that has a hydrogen chloride concentration of less than the saturation value. Here, it is known that the saturation concentration of hydrochloric acid varies depending on the liquid temperature even under normal pressure, and to be for example, 43.3% by mass at a liquid temperature of 10° C., 41.8% by mass at a liquid temperature of 20° C., 38.8% by mass at 30° C., 37.3% by mass at 40° C., 35.9% by mass at 50° C., and 34.8% by mass at 60° C.

From the viewpoint of enhancing the removal effect of low-boiling-point impurities, the hydrogen chloride concentration of the crude hydrochloric acid is lower than the saturation value of hydrogen chloride at its liquid temperature by a value of preferably 2.0% by mass or more, more suitably 3.0% by mass or more. On the other hand, if the hydrogen chloride concentration of the crude hydrochloric acid is too low, it is not easily available, and a larger gas-liquid contact device for hydrogen chloride gas is required as well, and therefore, it is lower than the saturation value of hydrogen chloride at the liquid temperature of the crude hydrochloric acid by a value of preferably 15.0% by mass or less, more suitably 8.0% by mass or less. That is, when the saturation concentration of hydrogen chloride is 40.0% by mass, the hydrogen chloride concentration of the crude hydrochloric acid is preferably 25.0% by mass or more and 38.0% by mass or less, more suitably 32.0% by mass or more and 37.0% by mass or less.

In the present invention, the low-boiling-point impurities contained in the crude hydrochloric acid refer to compounds with a boiling point of −65° C. or lower, suitably −80° C. or lower, with which it becomes difficult to separate from hydrogen chloride by distillation. Specifically, the crude hydrochloric acid contains unreacted raw materials such as hydrogen if it is the synthetic hydrochloric acid, contains methane, ethylene, acetylene, and other materials if it is obtained from the byproduct hydrogen chloride gas, and further contains nitrogen, oxygen, argon, and other materials due to the atmospheric components. In the present invention, the crude hydrochloric acid contains at least one selected from hydrogen, nitrogen, oxygen, methane, ethylene, and acetylene among the above low-boiling-point impurities, in an amount of more than 0.1 ppm by mass (mass ppm) each, more suitably more than 0.2 ppm by mass, and particularly suitably more than 0.25 ppm by mass, which is preferable because its purification effect is remarkably exerted.

In the case where the crude hydrochloric acid is synthetic hydrochloric acid synthesized directly by the reaction of chlorine and hydrogen, which will be mentioned later, mainly as the low-boiling-point impurities, hydrogen is contained in an amount of more than 1 ppm by mass, more suitably more than 2 ppm by mass, nitrogen in an amount of more than 10 ppm by mass, more suitably more than 20 ppm by mass, and oxygen in an amount of more than 2 ppm by mass, more suitably more than 4 ppm by mass, in general. On the other hand, in the case where the crude hydrochloric acid is byproduct hydrochloric acid obtained by allowing byproduct hydrogen chloride gas produced in the vinyl chloride production process to be absorbed by water, which will be mentioned later, as the main low-boiling-point impurities, ethylene is contained in an amount of more than 0.5 ppm by mass, more suitably more than 1 ppm by mass, acetylene in an amount of more than 4 ppm by mass, more suitably more than 8 ppm by mass, nitrogen in an amount of more than 2 ppm by mass, more suitably more than 4 ppm by mass, and oxygen in an amount of more than 1 ppm by mass, more suitably more than 2 ppm by mass, in general.

Note that too large contents of low-boiling-point impurities contained in the crude hydrochloric acid may result in insufficient removal, and therefore, the low-boiling-point impurities selected from hydrogen, nitrogen, oxygen, methane, ethylene, and acetylene described above are each preferably at 100 ppm by mass or less, more suitably at 50 ppm by mass or less. Also, the total amount of these low-boiling-point impurities selected from hydrogen, nitrogen, oxygen, methane, ethylene, and acetylene is preferably 200 ppm by mass or less, more suitably 100 ppm by mass or less.

In the present invention, the crude hydrochloric acid is not particularly limited as long as it satisfies the aforementioned requirements, and those commercially available or internally produced can be used. In the case of internal production, examples of the crude hydrochloric acid include those obtained by allowing synthetic hydrogen chloride gas synthesized directly by the reaction of chlorine and hydrogen, or byproduct hydrogen chloride gas produced in the production process of chlorinated hydrocarbons such as vinyl chloride, methylene chloride, chloroform, and chlorobenzene, in the fluorocarbon production process, in the urethane production process, in the polycarbonate production process, or in other processes, to be absorbed by water. Among these, those obtained by dissolving synthetic hydrogen chloride gas obtained by the reaction of chlorine and hydrogen in water are preferable because of their high purity.

In the method of the present invention, hydrogen chloride gas is brought into gas-liquid contact with the crude hydrochloric acid that has a hydrogen chloride concentration of less than the saturation value and that contains low-boiling-point impurities. The biggest feature of the present invention is that this gas-liquid contact is further continued after the hydrogen chloride concentration reaches the saturation value until an excess amount of 0.1% or more of the mass of the saturated hydrochloric acid has been subjected to the contact treatment. This makes it possible to highly remove the low-boiling-point impurities contained in the crude hydrochloric acid.

That is, by bringing hydrogen chloride gas into gas-liquid contact with the crude hydrochloric acid, the hydrogen chloride gas is dissolved in the crude hydrochloric acid and its concentration increases until reaching the saturation value. This allows the low-boiling-point impurities in the obtained saturated hydrochloric acid to be in a state that can be easily removed to the gas phase. This phenomenon can be explained by the salting-out effect, in which the solubility of low molecules and organic matter decreases in aqueous solutions containing high concentrations of electrolytes. Then, in the present invention, gas-liquid contact with the hydrogen chloride gas is further continued from this state until an excess amount of 0.1% or more of the mass of the saturated hydrochloric acid has been subjected to the contact treatment, thus enabling the low-boiling-point impurities to be released to the gas phase at high efficiency.

Specifically, when the crude hydrochloric acid contains at least one low-boiling-point impurities selected from hydrogen, nitrogen, oxygen, methane, ethylene, and acetylene in an amount of more than 0.2 ppm by mass each, the contents of the low-boiling-point impurities contained in excess of the above amount can be reduced to 0.2 ppm by mass or less each, more suitably to 0.1 ppm by mass or less each. In particular, the above-described nitrogen and oxygen may be difficult to be removed sufficiently, and in some cases may even increase, when these are employed as the inert gas that is brought into gas-liquid contact with the crude hydrochloric acid: however, according to the present invention, hydrogen chloride gas, which is the target substance of the purification itself, is used as the gas component that is brought into such gas-liquid contact, making it possible to highly reduce even nitrogen and oxygen as well. Of course, when compared with the case where other inert gas components (such as argon), other than the above-described nitrogen and oxygen, that are not normally contained in the crude hydrochloric acid, are used as the gas component that is brought into gas-liquid contact with the crude hydrochloric acid, new contamination by these other foreign gas components and resulting decrease in purity can also be well prevented.

In the present invention, gas-liquid contact of the hydrogen chloride gas needs to be continued until an excess amount of 0.1% or more of the mass of the saturated hydrochloric acid has been subjected to the contact treatment in order to increase the removal efficiency of the low-boiling-point impurities. In the case where the contact amount of the hydrogen chloride gas is less than an excess amount of 0.1% of the mass of the saturated hydrochloric acid, nearly all of the hydrogen chloride gas may be absorbed by the crude hydrochloric acid, in which case the release of low-boiling-point impurities to the gas phase is not promoted and the removal effect is not fully exerted. In order to more highly remove the low-boiling-point impurities, it is particularly preferable that the contact amount of the hydrogen chloride gas be an excess amount of 0.2% or more of the mass of the saturated hydrochloric acid.

There is no particular restriction on the upper limit of the contact amount of the hydrogen chloride gas, but when the contact amount is too large, the amount of hydrogen chloride gas discharged to the gas phase increases, which is not preferable in terms of cost. For this reason, it is desirable to limit it to an excess amount of 5.0% or less, more suitably 1.0% or less, of the mass of the saturated hydrochloric acid.

As the hydrogen chloride gas used for gas-liquid contact, commercially available hydrogen chloride gas or those internally produced from the same origin as described for the crude hydrochloric acid subjected to the method of the present invention may be used without restrictions. Needless to say, it is preferable to use hydrogen chloride gas with purity as high as possible so that the resulting hydrochloric acid have higher purity. Specifically, the hydrogen chloride gas used preferably has a purity of 99.9% by mass or more, particularly 99.99% by mass or more, excluding moisture. Also, it is particularly preferable to use any of the low-boiling-point impurities selected from hydrogen, nitrogen, oxygen, methane, ethylene, and acetylene contained in hydrogen chloride gas is in an amount of 15 molar ppm or less, more suitably 5 molar ppm or less.

As will be mentioned in further detail later, the use of hydrogen chloride gas obtained by distillation or dissipation of high-purity hydrochloric acid produced by the method of the present invention in circulation as such high-purity hydrogen chloride gas is a particularly suitable aspect from the viewpoint of efficiency.

As for the method for bringing the hydrogen chloride gas into gas-liquid contact with the crude hydrochloric acid, any known gas-liquid contact methods may be employed as appropriate. For example, it is preferably performed by gas absorption columns such as wetted-wall columns, packed columns, spray columns, bubble columns, and bubble cap columns, and among these, it is particularly preferably performed by packed columns. As the packing material to be packed in packed columns, existing materials can be used, such as Raschig rings, Pall rings, and SPIRAX (registered trademark). In these gas absorption columns, it is preferable to distribute the crude hydrochloric acid from the upper side to the lower side and distribute the hydrogen chloride gas from the lower side to the upper side, bringing them into counterflow contact from the standpoint of efficiency.

In gas-liquid contact, it is desirable to adjust the respective temperatures of the crude hydrochloric acid and the hydrogen chloride gas, or the heating and cooling of the device, such that the temperature of the resulting high-purity hydrochloric acid is in the range of 5 to 60° C. Lower liquid temperatures of the crude hydrochloric acid tend to result in higher removal efficiency of the low-boiling-point impurities, but if the temperature is too low, freezing may occur, which is not preferable. For this reason, the liquid temperature of the crude hydrochloric acid is desirably 20 to 45° C., more suitably 25 to 40° C.

The above-described production of high-purity hydrochloric acid of the present invention can be performed, for example, using the high-purity hydrochloric acid producing device of the present invention. Examples of such a high-purity hydrochloric acid producing device of the present invention include a device comprising a gas absorption column equipped with the following: a crude hydrochloric acid supply pipe connected at an upper part and that supplies crude hydrochloric acid that has a hydrogen chloride concentration of less than the saturation value; a hydrogen chloride gas supply pipe connected at a lower part and that supplies high-purity hydrogen chloride gas: a high-purity hydrochloric acid take-out pipe connected at the bottom part; and a hydrogen chloride gas discharge pipe connected at the top part. The high-purity hydrochloric acid producing device of the present invention can efficiently carry out gas-liquid contact by distributing the crude hydrochloric acid from the upper side to the lower side and distributing the hydrogen chloride gas from the lower side to the upper side, bringing them into counterflow contact. Examples of the gas absorption column include a wetted-wall column, a packed column, a spray column, a bubble column, and a bubble cap column. Note that the high-purity hydrochloric acid take-out pipe may be arranged at any location on the lower side of the hydrogen chloride gas supply pipe, and the hydrogen chloride gas discharge pipe may be arranged at any location on the upper side of the crude hydrochloric acid supply pipe.

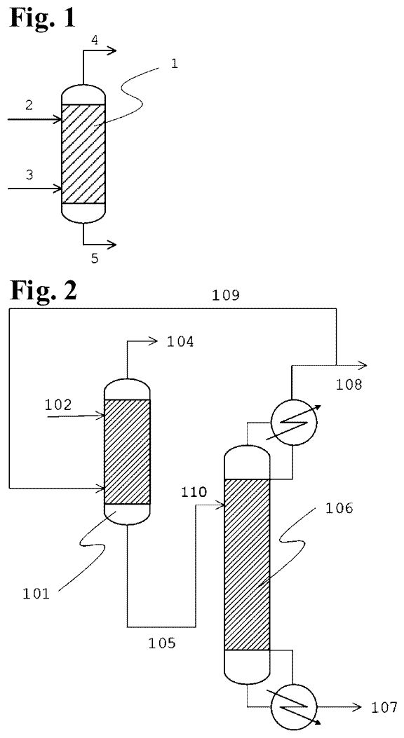

A flow diagram of the method for producing high-purity hydrochloric acid of the present invention is shown as FIG. 1, which illustrates a representative aspect thereof. In FIG. 1, in a packed column 1, crude hydrochloric acid that has a hydrogen chloride concentration of less than the saturation value and that contains low-boiling-point impurities is supplied from a crude hydrochloric acid supply pipe 2 connected at an upper part. On the other hand, hydrogen chloride gas is supplied from a hydrogen chloride gas supply pipe 3 connected at a lower part of the packed column 1. As a result, in the packed column 1, the crude hydrochloric acid is distributed from the upper side to the lower side and the hydrogen chloride gas is distributed from the lower side to the upper side, bringing them into counterflow contact. During the process of this counterflow contact, the contact treatment is further continued after the hydrogen chloride concentration of the crude hydrochloric acid increases and reaches the saturation value until it becomes an excess amount of 0.1% or more of the mass of the saturated hydrochloric acid. As a result of this, the low-boiling-point impurities contained in the crude hydrochloric acid are highly released and removed to the gas phase, and are discharged together with hydrogen chloride gas out of the system from a hydrogen chloride gas discharge pipe 4 connected at the top part of the packed column 1. In such a manner, high-purity hydrochloric acid with the saturation concentration, from which the low-boiling-point impurities have been removed, is stored at the bottom part of the packed column 1, and can be acquired from a high-purity hydrochloric acid take-out pipe 5.

The high-purity hydrochloric acid produced by the above method is saturated hydrochloric acid from which low-boiling-point impurities are highly removed. Such high-purity hydrochloric acid can be used for the aforementioned semiconductor manufacturing applications by applying other purification means or by diluting it, for example, if desired.

In semiconductor applications, high-purity hydrochloric acid needs to be vaporized to form high-purity hydrogen chloride gas when used as a gas agent such as etching gas or cleaning gas. Also, in the case where the crude hydrochloric acid contains not only low-boiling-point impurities but also metallic impurities, gas-liquid contact with hydrogen chloride gas leaves these metal impurities behind, and therefore, their removal is required as well. Accordingly, in these cases, it is preferable that the high-purity hydrochloric acid obtained by the present invention be subsequently subjected to distillation or dissipation to recover it as hydrogen chloride gas.

Such production (recovery) of high-purity hydrogen chloride gas can be performed, for example, using the high-purity hydrogen chloride gas producing system of the present invention. Examples of such a high-purity hydrogen chloride gas producing system of the present invention include a system comprising the above-described high-purity hydrochloric acid producing device of the present invention and a high-purity hydrogen chloride gas producing device. Specifically, the high-purity hydrogen chloride gas producing system of the present invention is a system in which the high-purity hydrogen chloride gas producing device comprises a gasification column equipped with the following: a high-purity hydrochloric acid supply pipe that supplies high-purity hydrochloric acid: a high-purity hydrogen chloride gas take-out pipe connected at the top part; and a column bottom liquid discharge pipe connected at the bottom part, wherein the high-purity hydrochloric acid take-out pipe of the high-purity hydrochloric acid producing device and the high-purity hydrochloric acid supply pipe of the high-purity hydrogen chloride gas producing device are connected, and the high-purity hydrogen chloride gas take-out pipe of the high-purity hydrogen chloride gas producing device and the hydrogen chloride gas supply pipe of the high-purity hydrochloric acid producing device are connected.

That is, the high-purity hydrogen chloride gas producing system of the present invention is a production system constructing a circulation system in which the high-purity hydrochloric acid produced in the high-purity hydrochloric acid producing device is supplied to the high-purity hydrogen chloride gas producing device, and a part of the high-purity hydrogen chloride gas produced in the high-purity hydrogen chloride gas producing device is supplied to the high-purity hydrochloric acid producing device. Examples of the gasification column in the high-purity hydrogen chloride gas producing device include a distillation column and a dissipation column. Also, the high-purity hydrogen chloride gas take-out pipe of the high-purity hydrogen chloride gas producing device connected to the hydrogen chloride gas supply pipe of the high-purity hydrochloric acid producing device may be a separate take-out pipe independent of the main take-out pipe, or it may be a branch pipe branched from the main take-out pipe.

A flow diagram of the method for producing high-purity hydrogen chloride gas is shown as FIG. 2, which is a representative aspect thereof.

In the method for producing high-purity hydrogen chloride gas shown in FIG. 2, the removal step of low-boiling-point impurities from crude hydrochloric acid using a packed column 101 may be performed in the same manner as in the production of high-purity hydrochloric acid by the packed column 1, as described in FIG. 1 above. Subsequently, in the aspect of FIG. 2, the high-purity hydrochloric acid taken out from a high-purity hydrochloric acid take-out pipe 105 is supplied to a distillation column 106 through a high-purity hydrochloric acid supply pipe 110 connected to the high-purity hydrochloric acid take-out pipe 105, and is distilled in the column. Through this distillation, the metallic impurities contained in the high-purity hydrochloric acid are concentrated in the column bottom liquid and discharged out of the system through a column bottom liquid discharge pipe 107 connected at the bottom part. On the other hand, high-purity hydrogen chloride gas from which the above metallic impurities have been removed is taken out from a high-purity hydrogen chloride gas take-out pipe 108 connected at the top part. This high-purity hydrogen chloride gas may be subjected to other purification means as necessary, then compressed and liquefied, stored and transported in cylinders, tanks, or the like, and vaporized for use at use points such as semiconductor manufacturing processes. Alternatively, the high-purity hydrogen chloride gas may be absorbed again by water and transported as high-purity hydrochloric acid for use at use points such as semiconductor manufacturing processes.

Note that, in the method for producing high-purity hydrogen chloride gas shown in FIG. 2 above, the vaporization of hydrogen chloride gas from high-purity hydrochloric acid is performed by the distillation column 106, which may be replaced by a dissipation column instead. Here, distillation refers to, for example, the use of a device that has a concentration section on the upper side of the supply position of the treated liquid and a recovery section on the lower side of the supply position in the column, while dissipation refers to, for example, the use of a device that supplies raw materials from the column top and does not have a concentration section in the column.

In the method of FIG. 2, distillation or dissipation can be performed in a batch manner, but it is preferably performed in a continuous manner. As the device for performing distillation or dissipation, any known distillation columns or dissipation columns, such as packed columns or plate columns, can be used. Further, as the packing material to be packed in packed columns, existing materials can be used, such as Raschig rings, Pall rings, and SPIRAX (registered trademark). Note that, in order to increase the purity, dehydration rate, and yield of hydrogen chloride gas, it is effective to have a condenser at the column top and to circulate a part of the hydrogen chloride gas to the column, in both distillation and dissipation. The temperature in distillation or dissipation is preferably under conditions of a column bottom temperature of 60 to 108° C. and a column top temperature of 60° C. or lower.

When exemplifying the metallic impurities removed by such distillation or dissipation, the main types are the following 18: boron, sodium, aluminum, phosphorus, calcium, titanium, chromium, iron, nickel, copper, zinc, arsenic, molybdenum, cadmium, antimony, tungsten, lead, and bismuth, but 20 other types are also covered, including lithium, beryllium, magnesium, silicon, potassium, vanadium, manganese, cobalt, gallium, germanium, strontium, zirconium, niobium, silver, tin, barium, tantalum, gold, mercury, and thallium.

Although the total content of metallic impurities composed of each of these 38 elements in the high-purity hydrochloric acid obtained by gas-liquid contact with hydrogen chloride gas may be 50 ppb by mass or more, or 100 ppb by mass or more in the case of severe contamination, the content can be reduced to 1.0 ppb by mass or less, more suitably to 0.7 ppb by mass or less, by subjecting it to distillation or dissipation.

In addition, when hydrogen bromide (normally 5 to 200 ppm by mass) is contained in the hydrochloric acid, it can also be concentrated in the column bottom liquid and removed since the boiling point of hydrogen bromide (−66° C.) is higher than the boiling point of hydrogen chloride. As a result of this, high-purity hydrogen chloride gas with the content of the above hydrogen bromide cleaned to less than 0.1 molar ppm can also be obtained. Similarly, in the case where the byproduct hydrogen chloride gas produced in the vinyl chloride production process is used as a raw material, low molecular weight carboxylic acids such as formic acid and acetic acid are contained in hydrochloric acid in an amount of 3 ppm by mass or more, more generally 6 to 20 ppm by mass, but by distillation or dissipation under the above conditions, these organic impurities can be well removed.

Note that by such distillation or dissipation high-purity hydrogen chloride gas is obtained from the column top, but if low-boiling-point impurities remain in the hydrochloric acid subjected to the treatment, they are also discharged from the column top side. As a result, the low-boiling-point impurities are contained in the hydrogen chloride gas in a slightly higher amount compared to the value in the hydrochloric acid subjected to the treatment. This means that, for example, if the respective contents of low-boiling-point impurities in the hydrochloric acid are reduced to 0.01 ppm by mass or less for hydrogen, 0.1 ppm by mass or less for methane, and 0.2 ppm by mass or less for nitrogen, oxygen, ethylene, and acetylene, then their respective contents will be normally increased only by the range of 1.0 molar ppm or less.

In this manner, according to the method for producing high-purity hydrogen chloride gas shown in FIG. 2, hydrogen chloride gas with extremely high purity can be obtained. Accordingly, if a part of it is used in circulation as the hydrogen chloride gas that is brought into gas-liquid contact with the crude hydrochloric acid, gas-liquid contact with the crude hydrochloric acid can be efficiently performed without installing additional facilities for preparing hydrogen chloride gas from the outside. As shown in the flow diagram of FIG. 2, the high-purity hydrogen chloride gas distributed through the high-purity hydrogen chloride gas take-out pipe 108 is branched and returned to the packed column 101 through a high-purity hydrogen chloride gas circulation pipe (high-purity hydrogen chloride gas supply pipe) 109, where it is well used as the hydrogen chloride gas that is brought into gas-liquid contact with the crude hydrochloric acid.

### EXAMPLES

Hereinafter, the present invention will be described in further detail with reference to Examples, but the present invention is not limited to these Examples. Note that measurements of physical properties performed in Examples and Comparative Examples were performed by the following methods.

### 1) Measurement of Amount of Low-Boiling-Point Impurities Contained in Hydrochloric Acid

By distilling hydrochloric acid in a quartz glass distillation device while distributing it, the amount of impurities in the resulting gas-phase gas was measured by the method described in 2) and then converted to the total amount of impurities in the hydrochloric acid.

### 2) Measurement of Amount of Low-Boiling-Point Impurities Contained in Hydrogen Chloride Gas

By distributing a specified amount of hydrogen chloride gas through an adsorption column using helium as the carrier gas, hydrogen chloride gas was adsorbed and removed, and the residual gas was quantified by analyzing it by gas chromatography.

### 3) Measurement of Amount of Metallic Impurities Contained in Hydrochloric Acid

Inductively coupled plasma mass spectrometry (ICP-MS) was used for quantification. The measurement was performed for a total of 38 metallic elements: boron, sodium, aluminum, phosphorus, calcium, titanium, chromium, iron, nickel, copper, zinc, arsenic, molybdenum, cadmium, antimony, tungsten, lead, bismuth, lithium, beryllium, magnesium, silicon, potassium, vanadium, manganese, cobalt, gallium, germanium, strontium, zirconium, niobium, silver, tin, barium, tantalum, gold, mercury, and thallium.

### 4) Measurement of Amount of Metallic Impurities Contained in Hydrogen Chloride Gas

Hydrochloric acid obtained by allowing ultrapure water to absorb an arbitrary amount of hydrogen chloride gas was analyzed by the method described in 3), and then the total amount of impurities in the hydrochloric acid was converted assuming that they were derived from the hydrogen chloride gas.

### Example 1

Using a device composed of the production flow shown in FIG. 1, production of high-purity hydrochloric acid was performed.

The raw material crude hydrochloric acid used was obtained by allowing water to absorb byproduct hydrogen chloride gas produced in the vinyl chloride production process. The hydrochloric acid had a hydrogen chloride concentration of 32.0% by mass, and contained 9 ppm by mass of acetylene, 1 ppm by mass of ethylene, 5 ppm by mass of nitrogen, and 2 ppm by mass of oxygen as the main low-boiling-point impurities. It also contained, as the main metallic impurities, 0.4 ppb by mass of boron, 1.4 ppb by mass of sodium, 0.2 ppb by mass of magnesium, 0.2 ppb by mass of aluminum, 0.8 ppb by mass of calcium, 0.7 ppb by mass of iron, 0.6 ppb by mass of nickel, 0.2 ppb by mass of copper, and 0.6 ppb by mass of zinc, and the total content of the 38 metallic elements was 5.1 ppb by mass. Furthermore, the above crude hydrochloric acid contained 20 ppm by mass of hydrogen bromide as other main impurity.

Based on FIG. 1, the crude hydrochloric acid was supplied at a liquid temperature of 30° C. (the saturation concentration of hydrochloric acid is 38.8% by mass) and at a flow rate of 10.0 kg/h through the crude hydrochloric acid supply pipe 2 to an upper part of the packed column 1, which was packed with irregular packing materials (Raschig rings) made of resin, and was allowed to flow down inside the packed column 1. On the other hand, high-purity hydrogen chloride gas with a purity of 99.999% or more was supplied at a temperature of 30° C. and at a flow rate of 662 g/h (407 NL/h) through the hydrogen chloride gas supply pipe 3 to a lower part of the packed column 1, and was brought into gas-liquid contact (counterflow contact) with the crude hydrochloric acid. Here, the above high-purity hydrogen chloride gas was clean, in which the contents of any of the low-boiling-point impurities selected from hydrogen, nitrogen, oxygen, methane, ethylene, and acetylene were 1 molar ppm or less, and the contents of metallic impurities were 0.1 ppb by mass or less for any of the main 38 elements.

As a result of the above gas-liquid contact, saturated hydrochloric acid (49° C.) with a hydrogen chloride concentration of 36.1% by mass was obtained at a flow rate of 10.6 kg/h from the high-purity hydrochloric acid take-out pipe 5 connected to the column bottom. This gas-liquid contact was performed under conditions where hydrogen chloride was brought into contact in an amount including, in addition the amount of hydrogen chloride required to obtain saturated hydrochloric acid, an excess amount of 0.2% of the mass of the resulting saturated hydrochloric acid. Note that the discharged gas volume from the hydrogen chloride gas discharge pipe 4 connected to the column top was 15 NL/h.

When the contents of low-boiling-point impurities were measured for the hydrochloric acid obtained from the above high-purity hydrochloric acid take-out pipe 5, acetylene was 0.04 ppm by mass, and ethylene, nitrogen, and oxygen were all less than 0.05 ppm by mass, indicating extremely high purity.

### Example 2

Using a device composed of the production flow shown in FIG. 2, production of high-purity hydrogen chloride gas was performed.

The removal step of low-boiling-point impurities from crude hydrochloric acid using the packed column 101 in FIG. 2 was performed in the same manner as in the production of high-purity hydrochloric acid in Example 1. Note that the high-purity hydrogen chloride gas supplied from the hydrogen chloride gas supply pipe 3 to the packed column 1 was performed by distilling the high-purity hydrochloric acid discharged from the packed column 1 to the high-purity hydrochloric acid take-out pipe 105 in the removal step of low-boiling-point impurities in the distillation column 106, which will be mentioned later, extracting a part of the hydrogen chloride gas that flowed out into the high-purity hydrogen chloride gas take-out pipe 108 into the high-purity hydrogen chloride gas circulation pipe 109 (407 NL/h min), and returning it to the packed column 101.

The high-purity hydrochloric acid taken out from the high-purity hydrochloric acid take-out pipe 105 was introduced into the distillation column 106 at a flow rate of 10.6 kg/h, and distilled under conditions of a column bottom temperature of 110° C. and a column top temperature of 30° C. As a result, from the high-purity hydrogen chloride gas take-out pipe 108 connected to the column top, hydrogen chloride gas that had a hydrogen chloride concentration of 99.77% by mass and 0.23% by mass of moisture was obtained at a flow rate of 1270 NL/h.

Analysis of the low-boiling-point impurities in this hydrogen chloride gas showed that acetylene was 0.2 molar ppm, and ethylene, nitrogen, and oxygen were less than 0.05 molar ppm, indicating high purity. In addition, metallic impurities were 0.1 ppb by mass or less for any of the main 38 elements. Furthermore, the content of hydrogen bromide was less than 0.1 molar ppm.

Note that, from the column bottom liquid discharge pipe 107 at the column bottom, diluted hydrochloric acid 11 with a hydrogen chloride concentration of 20.7% by mass was discharged at a flow rate of 8.6 kg/h.

### Example 3

The raw material crude hydrochloric acid used was obtained by allowing water to absorb hydrogen chloride gas obtained by the synthesis of hydrogen and chlorine. The hydrochloric acid had a hydrogen chloride concentration of 32.0% by mass, and contained 2 ppm by mass of hydrogen, 30 ppm by mass of nitrogen, and 5 ppm by mass of oxygen as the main low-boiling-point impurities. It also contained, as the main metallic impurities, 103.3 ppb by mass of sodium, 11.1 ppb by mass of magnesium, 1.2 ppb by mass of aluminum, 33.1 ppb by mass of potassium, 35.5 ppb by mass of calcium, 0.2 ppb by mass of manganese, 15.3 ppb by mass of iron, 0.2 ppb by mass of nickel, 1.7 ppb by mass of zinc, 0.2 ppb by mass of strontium, 1.7 ppb by mass of barium, and 0.3 ppb by mass of lead, and the total content of the 38 metallic elements was 203.8 ppb by mass. Furthermore, the above crude hydrochloric acid contained 150 ppm by mass of hydrogen bromide as other main impurity.

In the same manner as in Example 1 based on FIG. 1, this crude hydrochloric acid was supplied to the packed column 1 at a flow rate of 10.0 kg/h, and on the other hand, high-purity hydrogen chloride gas with a purity of 99.999% or more was supplied thereto at a flow rate of 662 g/h (407 NL/h), bringing them into gas-liquid contact (low-boiling-point impurity removal step). As a result, from the high-purity hydrochloric acid take-out pipe 5 connected to the column bottom, saturated hydrochloric acid with a hydrogen chloride concentration of 36.1% by mass was obtained at a flow rate of 10.6 kg/h. This gas-liquid contact was performed under conditions where hydrogen chloride was brought into contact in an amount including, in addition the amount of hydrogen chloride required to obtain saturated hydrochloric acid, an excess amount of 0.2% of the mass of the resulting saturated hydrochloric acid. Note that the discharged gas volume from the hydrogen chloride gas discharge pipe 4 connected to the column top was 15 NL/h.

When the contents of low-boiling-point impurities were measured for the hydrochloric acid obtained from the above high-purity hydrochloric acid take-out pipe 5, hydrogen was reduced to less than 0.01 ppm by mass, and nitrogen and oxygen were all reduced to less than 0.05 ppm by mass.

### Example 4

Using a device composed of the production flow shown in FIG. 2, in the same manner as in Example 2, high-purity hydrogen chloride gas was produced from the high-purity hydrochloric acid obtained in Example 3.

The high-purity hydrochloric acid taken out from the high-purity hydrochloric acid take-out pipe 105 was introduced into the distillation column 106 at a flow rate of 10.6 kg/h, and distilled under conditions of a column bottom temperature of 110° C. and a column top temperature of 30° C. As a result, from the high-purity hydrogen chloride gas take-out pipe 108 at the column top, hydrogen chloride gas that had a hydrogen chloride concentration of 99.77% by mass and 0.23% by mass of moisture was obtained at a flow rate of 1270 NL/h.

Analysis of the low-boiling-point impurities in this hydrogen chloride gas showed that hydrogen, nitrogen, and oxygen were all less than 0.05 molar ppm, indicating high purity. In addition, metallic impurities were 0.1 ppb by mass or less for any of the main 38 elements. Furthermore, the content of hydrogen bromide was less than 0.1 molar ppm.

Note that, from the column bottom liquid discharge pipe 107 at the column bottom, diluted hydrochloric acid 11 with a hydrogen chloride concentration of 20.7% by mass was discharged at a flow rate of 8.6 kg/h.

### Comparative Example 1

In Example 2, crude hydrochloric acid of the same origin was used, the low-boiling-point impurity removal step according to Example 1 using the packed column 101 was not performed, and the crude hydrochloric acid was introduced directly into the distillation column 106 for distillation and purification.

Analysis of the low-boiling-point impurities in the obtained hydrogen chloride showed that, although metallic impurities were reduced to 0.1 ppb by mass or less for any of the main 38 elements, the low-boiling-point impurities were concentrated to 63 molar ppm for acetylene, 7 molar ppm for ethylene, 35 molar ppm for nitrogen, and 14 molar ppm for oxygen.

### Comparative Example 2

When performing the low-boiling-point impurity removal step from the crude hydrochloric acid by gas-liquid contact in the packed column 1 in Example 1, it was performed in the same manner except that high-purity nitrogen (purity of 99.999% or more) was used as the gas supplied to a lower part of the packed column 1 instead of the high-purity hydrogen chloride gas, and this was supplied to a lower part of the packed column 1 at a flow rate of 15 NL/h. Here, the amount of the above high-purity nitrogen supplied to a lower part of the packed column 1 was the amount corresponding to the excess amount calculated by subtracting the amount of high-purity hydrogen chloride gas required to be absorbed by high-purity hydrochloric acid to become saturated hydrochloric acid from the amount thereof supplied to a lower part of the packed column 1 [662 g/h (407 NL/h)] in Example 1, and in other words, it was the same amount as the discharged gas volume of hydrogen chloride gas [15 NL/h] from the packed column 1.

As a result of the above gas-liquid contact, hydrochloric acid (30° C.) with a hydrogen chloride concentration of 32.0% by mass was obtained at a flow rate of 10.0 kg/h from the high-purity hydrochloric acid take-out pipe 5 connected to the column bottom. The discharged gas volume discharged from the column top was 16 NL/h.

When the contents of low-boiling-point impurities were measured for the hydrochloric acid obtained from the high-purity hydrochloric acid take-out pipe 5, acetylene, ethylene, and oxygen were reduced to some extent to 5.6 ppm by mass, 0.6 ppm by mass, and 0.9 ppm by mass, respectively, but the content of nitrogen remained unchanged at 5 ppm by mass.

### Comparative Example 3

When performing the low-boiling-point impurity removal step from the crude hydrochloric acid by gas-liquid contact in the packed column 1 in Example 1, it was performed in the same manner except that high-purity air was used as the gas supplied to a lower part of the packed column 1 instead of the high-purity hydrogen chloride gas, and this was supplied to a lower part of the packed column 1 at a flow rate of 15 NL/h. Here, the amount of the above high-purity air supplied to a lower part of the packed column 1 was the amount corresponding to the excess amount calculated by subtracting the amount of high-purity hydrogen chloride gas required to be absorbed by high-purity hydrochloric acid to become saturated hydrochloric acid from the amount thereof supplied to a lower part of the packed column 1 [662 g/h (407 NL/h)] in Example 1, and in other words, it was the same amount as the discharged gas volume of hydrogen chloride gas [15 NL/h] from the packed column 1.

As a result of the above gas-liquid contact, hydrochloric acid (30° C.) with a hydrogen chloride concentration of 32.0% by mass was obtained at a flow rate of 10.0 kg/h from the high-purity hydrochloric acid take-out pipe 5 connected to the column bottom. The discharged gas volume discharged from the column top was 16 NL/h.

When the contents of low-boiling-point impurities were measured for the hydrochloric acid obtained from the high-purity hydrochloric acid take-out pipe 5, acetylene and ethylene were reduced to some extent to 5.6 ppm by mass and 0.6 ppm by mass, respectively, but the contents of nitrogen and oxygen remained unchanged at 5 ppm by mass and 2 ppm by mass, respectively.

### Comparative Example 4

When performing the low-boiling-point impurity removal step from the crude hydrochloric acid by gas-liquid contact in the packed column 1 in Example 1, it was performed in the same manner except that the supply amount of the high-purity hydrogen chloride gas supplied to a lower part of the packed column 1 was changed to a flow rate of 638 g/h (392 NL/h).

As a result of the above gas-liquid contact, saturated hydrochloric acid (49° C.) with a hydrogen chloride concentration of 36.1% by mass was obtained at a flow rate of 10.6 kg/h from the high-purity hydrochloric acid take-out pipe 5 connected to the column bottom. This gas-liquid contact was performed under conditions where hydrogen chloride was brought into contact in an amount required to obtain saturated hydrochloric acid. Note that all of the supplied hydrogen chloride gas was absorbed by the hydrochloric acid, and no discharging of discharged gas was observed from the hydrogen chloride gas discharge pipe 4 connected to the column top.

When the contents of low-boiling-point impurities were measured for the hydrochloric acid obtained from the high-purity hydrochloric acid take-out pipe 5, acetylene was 9 ppm by mass, ethylene was 1 ppm by mass, nitrogen was 5 ppm by mass, and oxygen was 2 ppm by mass, indicating almost no reduction effect.

1. A method for producing high-purity hydrochloric acid, comprising bringing hydrogen chloride gas into gas-liquid contact with crude hydrochloric acid that has a hydrogen chloride concentration of less than a saturation value and that contains low-boiling-point impurities, wherein the gas-liquid contact of the hydrogen chloride gas is further continued after the hydrogen chloride concentration reaches the saturation value until an excess amount of 0.1% or more of a mass of the saturated hydrochloric acid has been subjected to the contact treatment.

2. The method for producing high-purity hydrochloric acid according to claim 1, wherein the gas-liquid contact of the hydrogen chloride gas with the crude hydrochloric acid is performed by a gas absorption column.

3. The method for producing high-purity hydrochloric acid according to claim 1, wherein the crude hydrochloric acid contains at least one low-boiling-point impurities selected from hydrogen, nitrogen, oxygen, methane, ethylene, and acetylene in an amount of more than 0.2 ppm by mass each.

4. The method for producing high-purity hydrochloric acid according to claim 1, wherein the hydrogen chloride concentration of the crude hydrochloric acid is lower than the saturation value of hydrogen chloride at a liquid temperature of the crude hydrochloric acid by a value in a range of 2.0% by mass or more and 15.0% by mass or less.

5. The method for producing high-purity hydrochloric acid according to claim 1, wherein the crude hydrochloric acid is obtained by dissolving synthetic hydrogen chloride gas obtained by allowing chlorine and hydrogen to react with each other, in water.

6. The method for producing high-purity hydrochloric acid according to claim 1, wherein any of the low-boiling-point impurities selected from hydrogen, nitrogen, oxygen, methane, ethylene, and acetylene contained in the hydrogen chloride gas that is brought into gas-liquid contact with the crude hydrochloric acid is in an amount of 15 molar ppm or less.

7. The method for producing high-purity hydrochloric acid according to claim 1, wherein the hydrogen chloride gas that is brought into gas-liquid contact with the crude hydrochloric acid is obtained by distillation or dissipation of hydrochloric acid.

8. The method for producing high-purity hydrochloric acid according to claim 1, wherein hydrogen chloride gas obtained by vaporizing the produced high-purity hydrochloric acid is used in circulation as the hydrogen chloride gas that is brought into gas-liquid contact with the crude hydrochloric acid.

9. A method for producing high-purity hydrogen chloride gas, wherein high-purity hydrochloric acid produced by the method according to claim 1 is subjected to distillation or dissipation to vaporize hydrogen chloride.

10. A high-purity hydrochloric acid producing device comprising a gas absorption column equipped with the following: a crude hydrochloric acid supply pipe connected at an upper part and that supplies crude hydrochloric acid having a hydrogen chloride concentration of less than a saturation value; a hydrogen chloride gas supply pipe connected at a lower part and that supplies high-purity hydrogen chloride gas; a high-purity hydrochloric acid take-out pipe connected at a bottom part; and a hydrogen chloride gas discharge pipe connected at a top part.

11. A high-purity hydrogen chloride gas producing system comprising:
the high-purity hydrochloric acid producing device according to claim 10; and
a high-purity hydrogen chloride gas producing device comprising a gasification column equipped with the following: a high-purity hydrochloric acid supply pipe that supplies high-purity hydrochloric acid; a high-purity hydrogen chloride gas take-out pipe connected at a top part; and a column bottom liquid discharge pipe connected at a bottom part,
wherein the high-purity hydrochloric acid take-out pipe of the high-purity hydrochloric acid producing device and the high-purity hydrochloric acid supply pipe of the high-purity hydrogen chloride gas producing device are connected, and
the high-purity hydrogen chloride gas take-out pipe of the high-purity hydrogen chloride gas producing device and the hydrogen chloride gas supply pipe of the high-purity hydrochloric acid producing device are connected.
